(19) United States
(12) Patent Application Publication
(10) Pub. No.: US 2014/0283700 A1
(43) Pub. Date: Sep. 25, 2014

(54) PRINTING BLANKET UTILIZING MULTI-PLY WOVEN FABRIC

(71) Applicant: Cosgrove David S., Jonesville, SC (US)

(72) Inventor: Cosgrove David S., Jonesville, SC (US)

(21) Appl. No.: 13/849,905

(22) Filed: Mar. 25, 2013

(51) Int. Cl. B41N 10/04

(52) U.S. Cl. CPC B41N 10/04
USPC 101/401.1

(57) ABSTRACT

In accordance with at least one exemplary embodiment, the present disclosure provides advantages and alternatives over the prior art by providing a printing blanket containing a printing surface and a multi-ply woven fabric. The multi-ply woven fabric contains at least two woven plies, each of the woven plies having warp yarns in the warp direction and weft yarns in a weft direction perpendicular to the warp direction interwoven with the warp yarns. The woven plies are integrated through combined portions formed by interlacing warps and wefts among different woven plies within the multi-ply woven fabric.

### FIELD OF THE INVENTION

The present invention generally relates to printing blankets, more particularly to printing blankets utilizing a multi-ply woven fabric.

### BACKGROUND

One of the most common commercial printing processes is offset lithography. In this printing process, ink is offset from a printing plate to a rubber-surfaced printing blanket mounted on a blanket cylinder before being transferred to a substrate, such as paper.

Printing blankets for the offset printing process are typically manufactured to a very specific overall thickness to fit in a fixed gap on a printing press. The thickness in a traditional blanket is usually made up of some combination of layers of (typically woven) fabrics, rubber (including rubber with voids, commonly known as a compressible layer), adhesive (often as an adhesive rubber compound), and sometimes metal or polymeric sheeting. Typically, at least some of the woven fabrics reinforce the printing blanket, providing the majority of the desired low stretch (low residual elongation) and high tensile strength properties to the finished blanket. The thickness contribution of any of these components and/or the position of components within the blanket structure may be varied in a given blanket design for reasons of cost, specific performance attributes, or other reasons at the discretion of the blanket manufacturer.

In the majority of traditional blankets for offset printing, multiple individual single-ply woven fabrics (typically between two and four [inclusive]) are laminated together to build up a base for the blanket. This base may also be called the carcass. These fabric plies are typically adhered to one another by applying adhesive to at least one surface of at least one of the adjacent fabric plies, and then feeding the stacked fabric plies through a doubling process to bond them together in a laminar fashion.

It would be desirable to be able to provide a blanket construction having the desired tensioning properties, including low stretch (low residual elongation) and high tensile strength, which does not require the use of multiple fabric plies and would therefore eliminate the need for an adhesive application and doubling process to join said plies.

### BRIEF SUMMARY

In accordance with at least one exemplary embodiment, the present disclosure provides advantages and alternatives over the prior art by providing a printing blanket containing a printing surface and a multi-ply woven fabric. The multi-ply woven fabric contains at least two woven plies, each of the woven plies having warp yarns in the warp direction and weft yarns in a weft direction perpendicular to the warp direction and interwoven primarily with the warp yarns normally occupying the same ply. The woven plies are integrated through (often point-wise) combined portions formed by interlacing warps and wefts among different woven plies within the multi-ply woven fabric.

### BRIEF DESCRIPTION OF THE DRAWINGS

FIG. 1 illustrates one embodiment of the printing blanket.

FIG. 2 illustrates one embodiment of a multi-ply fabric.

FIGS. 3 and 4 show the weave diagram of two possible multi-ply fabrics.

### DETAILED DESCRIPTION

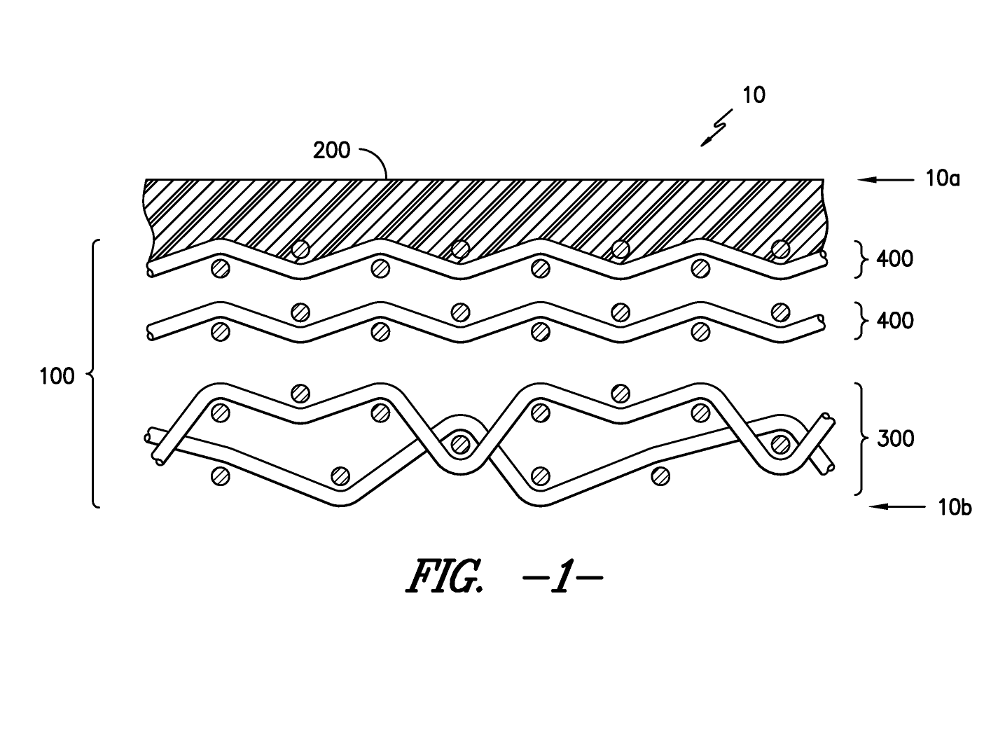

FIG. 1 illustrates one embodiment of the printing blanket 10 containing a printing side 10a which is the side of the printing blanket 10 which will be in contact with the ink from the plate cylinder (and also with the print media [e.g. paper]), and an inner side 10b opposite to the printing side 10a (to be in contact with the blanket cylinder once mounted). The printing blanket 10 contains a printing surface layer 200 on the printing side 10a of the printing blanket 10 and a base 100 behind the printing surface layer 200 which is formed at least partially from at least one fabric ply. In the embodiment shown in FIG. 1, the base 100 contains one multi-ply woven fabric 300 (which contains two plies woven together) and two single-ply woven fabrics 400. Each of the separable (i.e. not woven together) fabric plies is typically adhered to the other fabric plies using an adhesive or an adhesive rubber compound (not shown). To further clarify, the top surface of the topmost ply (closest to blanket printing side 10a) in the multi-ply woven fabric 300 would be adhered to the bottom surface of the single-ply fabric 400 located immediately above it in FIG. 1. Insomuch as multiple fabric plies can be woven together during textile fabric formation, there is typically no need during printing blanket manufacture to apply adhesive or adhesive rubber between individual fabric plies contained wholly within a multi-ply fabric structure. “Printing blankets” may refer to blankets manufactured for any specific printing end use, market segment, or blanket category including but not limited to sheet-fed printing, web (tension) printing (both heat-set and cold-set), UV printing, varnishing, metal decorating, coating, packaging, metal-backed blankets (still containing interior fabric), polymeric-backed blankets (still containing interior fabric), adhesive-backed blankets, stripping blankets, under-packing blankets, and various specialty applications.

The multi-ply woven fabric 300 (sometimes also referred to as a multi-layer woven fabric) is used to replace two or more traditional single-ply fabrics (also known as single-layer fabrics) which would normally have been laminated together during printing blanket manufacture. The multi-ply woven fabric 300 is also often designed to have the necessary combined properties including low stretch (low residual elongation) and high tensile strength of the traditional single-ply fabrics it is replacing. Multi-ply woven fabrics 300 can simplify and reduce the cost of the printing blanket manufacturing process, produce less waste during the manufacture of a printing blanket, and can be engineered across a great breadth of physical properties and performance.

Multi-ply fabrics allow for an increase in warp and filling yarn densities (number of yarns present per unit of dimension) versus what would be possible in single-ply fabrics utilizing the same yarns (type and size) and the same basic weaves. Essentially, the invention takes the fabric doubling step requirement away from the printing blanket manufacturer, instead substituting a fabric containing two or more plies formed concurrently on the weaving machine. If a blanket design normally utilized two fully independent plies of fabric at about 15 mils (thousandths of an inch) each, a multi-ply fabric structure totaling about 30 to 32 mils of finished thickness and possessing the same load-bearing capabilities as the former two independent fabrics could be used instead. If a single-ply fabric for use in traditional printing blanket applications has a 180 pound per inch minimum tensile strength requirement (at break) in the warp direction, a multi-ply fabric intended to be used to replace two such fabrics in a blanket design might reasonably be expected to need to be able to support about 360 pounds per inch in the warp direction prior to tensile failure.

The multi-ply woven fabric 300 contains at least two woven plies.

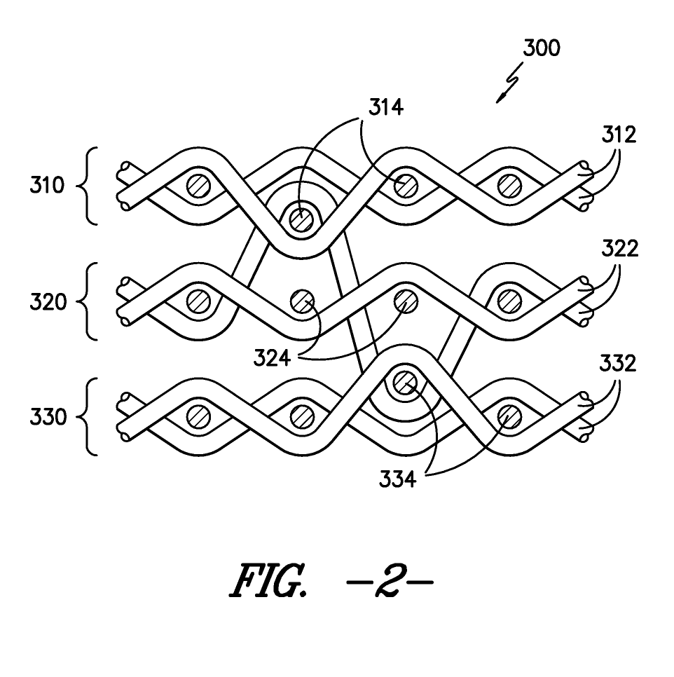

Each of the woven plies has a plurality of warp yarns in the warp direction (also sometimes referred to as the machine direction) and a plurality of weft yarns in a weft direction (also sometimes referred to as the filling direction, the transverse direction, or the cross-machine direction) which is perpendicular to the warp direction. Within each woven ply, the warp yarns and the weft yarns are interwoven. The woven plies are integrated through (often point-wise) combined portions formed by interlacing warps and wefts among different woven plies within the multi-ply woven fabric. FIG. 2 illustrates one embodiment of the multi-ply woven fabric 300 containing three woven plies (310, 320, and 330). The first (or topmost) woven ply 310 contains warp yarns 312 interwoven with weft yarns 314. The second (or middle) woven ply 320 contains warp yarns 322 interwoven with weft yarns 324. The third (or bottommost) woven ply 330 contains warp yarns 332 interwoven with weft yarns 334. The three plies 310, 320, and 330 are integrated through combined portions, also called stitching points. These stitching points may be termed riser or sinker stiches depending on how the warp yarn is moved during manufacture of the fabric.

Multi-ply woven fabrics can be formed on a variety of different types of weaving machines, and are not constrained by any commonly-known modern method of weft insertion (shuttle, projectile, rapier, water jet, air jet, etc.). There is no limit to the theoretical fabric complexity, but there can be mechanical, material, or practical limits to such fabrics. Generally, the more complicated the desired multi-ply fabric structure, the greater degree of shedding complexity is required. This has much to do with the amount of individual warp end control required to stitch the fabric plies together into a single structure, as well as the layout and spacing of the desired stitching arrangement.

In typical single-ply woven fabrics, there is only one fabric layer, and all interlacing between the warp yarns and the weft yarns takes place within a single geometric plane. Therefore, there are not multiple plies or layers present to be stitched together. Not all single-ply woven fabrics utilize balanced or symmetric weaves, so it may be possible to have some “layering” of yarns into a predominantly warp surface and a predominantly weft surface (as in a satin weave, for example), but all interlacing still takes place in a single geometric plane, and this situation remains distinctly different from multi-ply woven fabrics, where each ply generally has its own corresponding “set” of warp yarns and weft yarns which only interact with other layers during stitching. Beginning with two or more independently produced single-ply fabrics, there are multiple possible methods for joining them. As already mentioned, the traditional method in the printing blanket realm is to apply adhesive or adhesive rubber between the fabric plies, and then bond them together under heat and pressure. It could also theoretically be possible to take individual single-ply fabrics and stitch them together in a secondary offline process (i.e. after fabric formation), as in quilting. This would require separate thread lines and auxiliary equipment (beyond a weaving machine) to accomplish, but would also have the probable adverse and undesirable effects of a more uneven surface due to the presence of additional yarns for stitching together, and also a weakening of the fabrics through the possibly destructive action of sewing needles piercing existing yarns within the fabrics being joined. With such a set-up, it would also be possible to create misalignment between the fabrics being joined, which could present major problems and excessive scrap in downstream processes.

True multi-ply woven fabrics are seamlessly and intimately joined during the weaving process via the (often point-wise) interlacing of warps and wefts among different woven plies within the multi-ply woven fabric. For example, referring to only the topmost two plies in FIG. 2 (which for illustrative purposes is showing more regular stitching than might otherwise be common or practical), warp yarns 322 in the middle ply 320 are normally and most frequently interlacing with weft yarns 324 within the same fabric ply. When it is desired to join the middle ply 320 with the topmost ply 310, a warp yarn 322 from the middle ply is raised above a weft yarn 314 in the top ply for one weft insertion cycle, and then lowered back to its normal position. This is sufficient to lock the two plies together at that point, and is called a riser stitch, or “stitching from back-to-face,” because the warp yarn is being raised from a lower ply to a higher ply on the weaving machine. Conversely, if a warp yarn was lowered from a higher ply to one below it, this would be termed a sinker stitch or “stitching from face-to-back.” It is certainly possible to have both types of stitching between two plies in the same multi-ply fabric structure. Disguising the location of such stitching points may or may not be a concern depending on end-use application. The frequency of stitching impacts the stability of the overall structure. If stitching is arranged very sparsely, each fabric ply will operate almost independently, and the overall multi-ply fabric structure may be prone to shifting. This would likely be undesirable in printing blanket applications.

In one embodiment, the multi-ply woven fabric comprises two woven plies. In another embodiment, the multi-ply woven fabric comprises three woven plies. In one embodiment, the multi-ply woven fabric comprises four woven plies. In another embodiment, the multi-ply woven fabric comprises at least two woven plies. In another embodiment, the multi-ply woven fabric comprises at least three woven plies. In another embodiment, the multi-ply woven fabric comprises at least four woven plies. The number of woven plies (whether as single-ply fabrics, or at least partially as plies within a multi-ply fabric) used in the base 100 of the printing blanket 10 is determined by the yarns and weave patterns selected by the fabric designer and the desired final properties of the blanket—particularly thickness.

In one embodiment, the multi-ply woven fabric has a tensile strength greater than about 250 pounds per inch (about 447×10² g/cm), more preferably, greater than about 300 pounds per inch (about 536×10² g/cm), and most preferably, greater than about 400 pounds per inch (about 714×10² g/cm) in at least the warp direction and preferably in both the warp and weft directions.

In one embodiment, the multi-ply woven fabric preferably has a residual stretch of less than about 4%, more preferably less than about 3%, and most preferably, less than about 2% (based on a 1 inch [2.54 cm] wide, 50 pound [22.7 kg] dead weight hang test) in at least the warp direction and preferably in both the warp and weft directions. The test procedure involves preparing a fabric strip of appropriate dimension (1 inch wide), pre-loading with 1 pound, applying gauge markings at a defined separation distance, loading the strip with 50 pounds of weight such that the strip is the only thing supporting the load, measuring the distance between gauge markings after 3 minutes under load have elapsed, and calculating the percent elongation beyond the original strip dimensions.

In one embodiment, the multi-ply woven fabric has a gauge of between about 13 mils and about 42 mils, more preferably between about 18 mils and 37 mils, and most preferably between about 24 mils and 34 mils. The gauge of the overall multi-ply woven fabric structure is not only dependent upon the number of plies present, but also on the size of the yarns and the weave designs selected. These factors can have just as much or more impact on gauge than the sheer number of plies present.

The yarns making up the multi-ply woven fabric may be any suitable yarn, and the multi-ply woven fabric may be constructed completely out of one type of yarn, or any number of different types of yarns. “Yarn,” in this application, as used herein includes a monofilament elongated body, a multifilament elongated body, ribbon, strip, fiber, tape, and the like. The term yarn includes a plurality of any one or combination of the above. The yarns may be of any suitable form such as spun staple yarn, monofilament, or multifilament, single component, bi-component, or multi-component, and have any suitable cross-sectional shape such as circular (round), multi-lobal, square or rectangular (tape), and oval.

Some suitable materials for the yarns include cotton, polyester, nylon ([or polyamide] including nylon 6, nylon 6,6, and nylon 4,6), acetate, triacetate, acrylic, aramids (including meta and para forms), carbon, fiberglass, PVA (polyvinyl alcohol), polyolefin, polyvinyl, polyethylene naphthalate (PEN), steel, polyacrylic, polytrimethylene terephthalate (PTT), polycyclohexane dimethylene terephthalate (PCT), polybutylene terephthalate (PBT), PET modified with polyethylene glycol (PEG), polylactic acid (PLA), polytrimethylene terephthalate, regenerated cellulosics (such as rayon or lyocell [Tencel]), elastomeric materials such as spandex, high-performance fibers such as the polyaramids and polyimides, other natural fibers such as linen, ramie, and hemp; proteinaceous materials such as silk, wool, and other animal hairs such as angora, alpaca, and vicuna; fiber reinforced polymers, thermosetting polymers, blends thereof, and mixtures thereof.

Generally, to assist with flexibility in the blanket manufacturing process and to reduce the possibility of assembly errors or unintended end product variation, it is preferable (whether using single-ply or multi-ply fabrics) to utilize weaves which are balanced and symmetrical (or reversible). This is accomplished by selecting weaves which present the same amount of warp yarn and the same amount of weft yarn (and look the same) on either outward-facing surface of the fabric structure. Note that this does not necessarily mean that the presentation of the warp yarn and the weft yarn are equal to one another. For instance, a given fabric may have 75% of its weight or volume in the warp direction, and only 25% in the weft direction, but yet could still be balanced and symmetrical (or reversible). This situation could occur by selecting different sizes and/or densities (number of yarns present per unit of dimension) in the warp and weft directions. Weave symmetry allows the printing blanket manufacturer to draw the fabric off a roll from either the top side or the bottom side as they see fit without worrying about visual or functional differences arising in the end product from their choice of thread-up. When utilizing multi-ply fabrics, it is possible to select weaves that would be considered asymmetrical or non-reversible in their single-ply state, but that when combined into a multi-ply structure in a specific manner, present an identical outward-facing surface. A good example of this is satin weaves. In a single-ply fabric, satins have a distinctly different face and back. One side is dominated by warp yarns, and the other side by weft yarns. This can make them problematic when used in a blanket as single plies due to the potential for operators to reverse them. However, when combined into a multi-ply fabric structure, the weaves of the individual plies can be arranged in such a manner that they present the same side to the exterior of the combined structure. That is, when using such weaves in a two-ply fabric, the warp-dominant face could be positioned on the top side of the topmost ply, and also on the bottom side of the bottommost ply, such that the overall structure would indeed be visually and functionally reversible. On the contrary, there may be a functional need to present two quite different outward facing surfaces in a multi-ply fabric structure. One might need to be dense and smooth with long yarn float lengths (for reasons of appearance) on the bottom surface of the blanket, while another surface might need to be very open and perhaps even somewhat irregular for reasons of improved mechanical adhesion to other layers of the printing blanket. Such a weave arrangement, though originally developed for an entirely different purpose and end use application is disclosed in commonly-assigned U.S. Pat. No. 6,323,144, which is incorporated herein by reference. Depending on desired fabric properties, the designer or engineer may choose to arrange the stitch points in a variety of patterns or densities. For multi-ply printing blanket fabrics, the stitches should be frequent enough to make the combined fabric firm enough for additional processing without shifting or bagging.

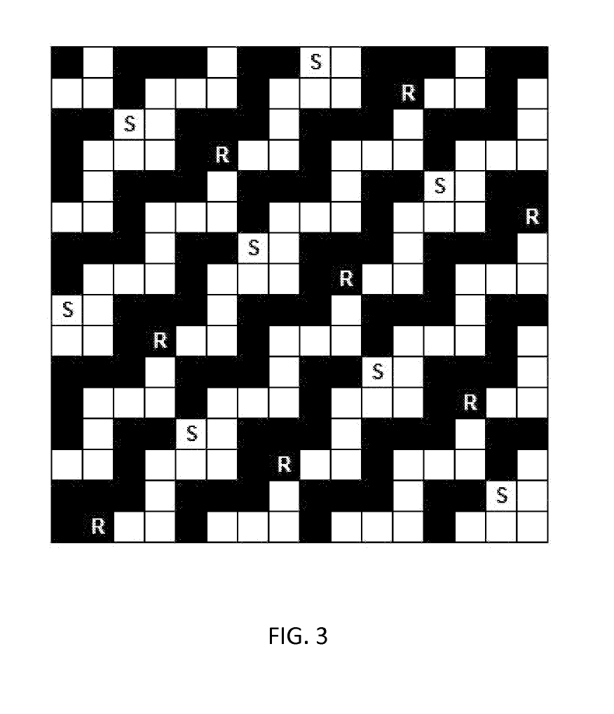

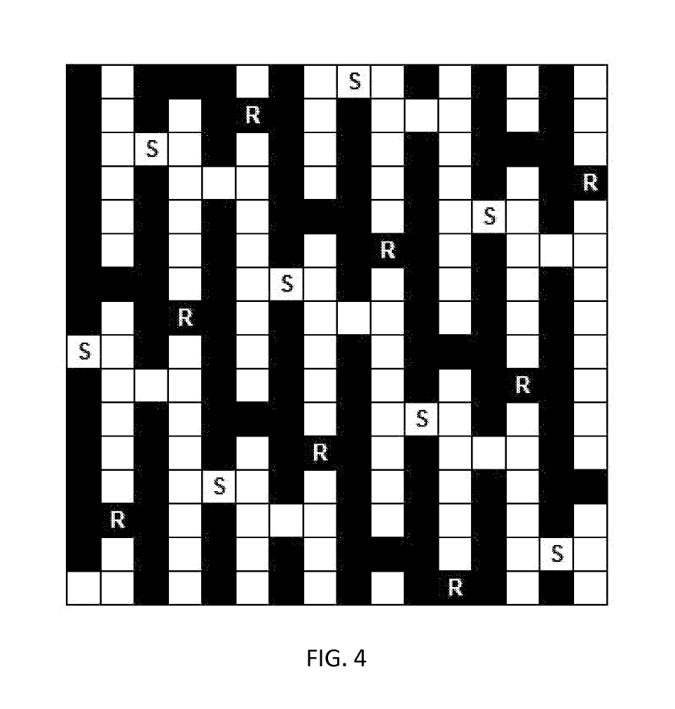

FIGS. 3 and 4 illustrate weave diagrams of two possible multi-ply fabrics for printing blanket applications. Each figure shows a two-ply woven fabric that has been formed together. In each figure, one square represents a possible intersection of a warp yarn and a weft yarn. By convention, a darkened square represents the warp yarn being in the up position at such an intersection during that particular weft insertion cycle, and an empty (or white) square represents the warp yarn being in the down position during that particular weft insertion cycle (so the weft yarn will float over the top of any such warp yarns). Stitching points are represented by squares marked with “R” or “S”. “R” represents a riser stitch (stitching from back-to-face), such that a yarn which would normally be in the bottom ply comes up to the top ply for a single weft insertion cycle, hooks a weft yarn in that ply, and then returns to its normal bottom ply position, thus stitching the two plies together at that point. “S” represents a sinker stitch (stitching from face-to-back), such that a yarn which would normally be in the top ply drops down to the bottom ply for a single weft insertion cycle, hooks a weft yarn in that ply, and then returns to its normal top ply position, thus stitching the two plies together at that point. If all stitching points were in the reverse arrangement (down if shown up, and up if shown down), the result would be two separate single-ply fabrics woven at the same time with no stitching—potentially only being connected by the fabric selvage (not shown), if at all. In both figures (3 and 4), odd numbered warp ends (counting from left to right) are weaving the top ply, and even numbered ends are weaving the bottom ply. Similarly, odd numbered weft yarns (counting from bottom to top) are weaving the top ply, and even numbered weft yarns are weaving the bottom ply. It is not necessary that the fabrics be set up in this manner. In fact, it is possible to have significantly more warp ends (or weft yarns) go into one fabric than the other, or to pattern the yarns in a different manner for functional or aesthetic effects. For example, in a two-ply fabric, it could be possible to have two or three warp ends weaving into the bottom ply for every one end weaving into the top ply, or vice versa. This would result in a multi-ply woven fabric with clearly differentiable properties between plies.

Occasionally, there is a need or desire on the part of printing blanket manufacturers for some type of chemical treatment to be applied only to a single side of a fabric. This may be because of aesthetic concerns (such as not wanting a possibly colored treatment visible on the outward-facing surface of the bottom fabric within a blanket), or because a treatment needed to successfully bond to something on one side of a fabric could interfere with bonding to another material on the opposite side.

In one embodiment, the multi-ply woven fabric, or any of the other layers within the printing blanket may be treated in a number of ways to improve adhesion and/or to impregnate and/or fill the fabric to further improve resistance to gauge loss, delamination, or wear. Preferably, the reinforcing fabric ply is heat set and RFL (resorcinol formaldehyde latex) treated to promote adhesion to various types of rubber. Other formulations for adhesion promotion may be substituted for RFL at the discretion of the textile finisher upon agreement with the blanket manufacturer. The reinforcing fabric ply is also preferably treated to resist gauge loss by impregnation of the individual fiber bundles with an elastomeric compound which may also function to promote adhesion. A preferred treatment method is disclosed in commonly-assigned U.S. Pat. No. 5,498,470, which is incorporated herein by reference.

In one embodiment, the multi-ply woven fabric may contain stuffer yarns. Stuffer yarns can be inserted between fabric plies to give additional thickness, or to give performance properties to the overall structure using yarns which may not be suitable for use on any exposed surfaces (due to reasons such as poor adhesion arising from surface character and/or selected polymer). Any suitable yarn may be used as a stuffer yarn depending on the end use of the fabric.

Stuffer yarns can be used to add additional thickness to a multi-ply fabric structure, and can often do so in a relatively cost-effective manner because the quality/grade of the yarn is not so important (assuming added thickness is the only goal) due to the fact that the stuffer yarns do not appear on the outer surfaces of the assembled structure. Therefore, lower grade raw materials can be utilized if desired/appropriate. Additionally, stuffer yarns allow for added thickness and weight without necessarily involving the perpendicular yarn direction. That is, stuffer yarns can be used in the weft direction or in the warp direction (a little more challenging) independently and in exclusion of the opposite yarn direction if desired. They can be considered as being like a sort of “half ply” of fabric (half because they are only one set of yarns floating between plies and do not have a corresponding set of perpendicular yarns with which they regularly interlace). Stuffer yarns in either direction will still be geometrically constrained by stitching points (at whatever density they may be present). Even though the stuffer yarns are essentially lying straight within the fabric and are not interlacing with another set of yarns, their lateral movement is constrained by stitching points connecting the two adjacent fabric plies between which the stuffer yarns float. Without regular stitching points, it would be possible for stuffer yarns to “slouch” or shift and bunch up between plies, which would generally not be desirable in printing blanket applications.

Other reasons for their use (in this case referring to the weft direction) could be to add unique performance properties to the fabric structure or to the assembled blanket, such as high tenacity in the weft direction, low elongation in the weft direction due to minimal crimping (the yarn floats between fabric plies and does not receive much if any crimp), improved gauge stability (e.g. by using rigid monofilament), anti-wicking properties, flame retardant properties, low melt properties for bonding cloth plies together from the inside, electrical and/or thermal conductivity properties, anti-microbial properties, etc. Because the stuffer yarns can be hidden away from exposed surfaces, it is easier to select the desired performance benefits without the occasional concerns about adhesion or appearance which may be raised if similar yarns were used in an exposed fabric ply. For example, using an untreated flat high tenacity polyester in an exposed fabric ply would almost certainly result in a reduced mechanical adhesion to a given rubber stock versus a more typical spun or textured yarn.

Referring again to FIG. 1, the printing surface layer 200 acts to transfer an inked image from a printing plate to a substrate and may be comprised of any suitable polymeric material including natural rubbers and synthetic resins. The multi-ply woven fabric 300 (or whichever fabric layer is directly below the printing surface layer 200) is preferably adhered to the printing surface layer 200 with an adhesive layer, which may comprise conventional adhesives including hot melt films.

The printing blanket 10 may optionally include a compressible layer between the printing surface layer 200 and the fabric layers of the base 100. The compressible layer is preferably formed from a compressible elastomeric material such as, for example, an elastomer composition as described in U.S. Pat. No. 4,770,928, incorporated herein by reference.

In addition to the multi-ply woven fabric 300, any other suitable fabric layer may also be used in the printing blanket 10 in order to meet the desired end product specifications of the printing blanket 10 such as gauge and tensile strength. The printing blanket 10 of Figure shows the base 100 containing two additional single woven fabric layers 400. The additional fabric layers may be woven, nonwoven, or knit and may be made of the same yarns as the multi-ply woven fabric 300 or different yarns. In one embodiment, the printing blanket contains two or more multi-ply woven fabrics. One example of this may be a base 100 containing two 2-ply woven fabrics for a total of four plies in the printing blanket 10.

In use, the printing blanket is mounted on a blanket cylinder by using conventional lock-up devices known in this art. In a certain segment of the printing market, the bottom surface of the completed printing blanket (inner side 10b) may be coated with a pressure-sensitive adhesive to be adhered to the blanket cylinder. This type of blanket does not require the conventional lock-up devices, but also is not typically subjected to the same stresses. Metal-backed blankets may utilize a different locking mechanism.

### EXAMPLES

### Example 1

A stitched two-ply plain weave fabric was formed using Ne (English Cotton Count) 20/2 ring spun 100% long staple warp yarns and Ne 18/1 open end (rotor) spun 65/35 polyester/cotton weft yarns. The finished fabric had 116 warp ends per inch and 96 weft picks per inch. The two fabric plies were joined together using both riser stitches (back-to-face) and sinker stitches (face-to-back) with each set of stitches arranged in offsetting 8-leaf satin order. This overall construction produced a very tight and sturdy fabric.

The combined two-ply fabric structure measured 26.5 mils thick using a delayed-action digital thickness gauge with a 0.625 inch diameter anvil and a head pressure of 5.8 pounds per square inch (E.J. Cady & Company DDW Model). The warp tensile strength was measured at just over 370 pounds force per inch of width using a 1 inch wide strip on an Instron tension testing machine with an initial jaw gap of 3 inches and a linear jaw expansion rate of 12 inches per minute. The weft tensile strength was measured at just over 155 pounds force per inch of length using the same testing set-up as described for the warp. The residual stretch measured after 3 minutes using the 50 pound dead weight hang test was 1.2%.

### Example 2

A stitched two-ply 8-leaf satin weave fabric was formed using Ne

(English Cotton Count) 20/2 ring spun 100% long staple warp yarns and Ne 18/1 open end (rotor) spun 65/35 polyester/cotton weft yarns. The finished fabric had 116 warp ends per inch and 118 weft picks per inch. The two fabric plies were joined together using both riser stitches (back-to-face) and sinker stitches (face-to-back) with each set of stitches arranged in offsetting 8-leaf satin order. The weave of each ply was arranged so that the warp dominant side of the fabric was oriented toward the outer surface of the assembled multi-ply fabric structure. Thus, the vast majority of the weft yarn was concealed in the interior. This overall construction produced a heavy, yet flexible fabric with good cover and a smooth appearance. It also reduced the beat-up forces on the weaving machine.

The combined two-ply fabric structure measured 36.5 mils thick using a delayed-action digital thickness gauge with a 0.625 inch diameter anvil and a head pressure of 5.8 pounds per square inch (E.J. Cady & Company DDW Model). The warp tensile strength was measured at just over 370 pounds force per inch of width using a 1 inch wide strip on an Instron tension testing machine with an initial jaw gap of 3 inches and a linear jaw expansion rate of 12 inches per minute. The weft tensile strength was measured at just over 185 pounds force per inch of length using the same testing set-up as described for the warp. The residual stretch measured after 3 minutes using the 50 pound dead weight hang test was 0.8%.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A printing blanket comprising a printing surface and a multi-ply woven fabric, wherein the multi-ply woven fabric comprises at least two woven plies, each of the woven plies comprising warp yarns in the warp direction and weft yarns in a weft direction perpendicular to the warp direction interwoven with the warp yarns, wherein the woven plies are integrated through combined portions formed by interlacing warps and wefts among different woven plies within the multi-ply woven fabric.

2. The printing blanket of claim 1, wherein the multi-ply woven fabric comprises at least 3 woven plies.

3. The printing blanket of claim 1, wherein the multi-ply woven fabric comprises at least 4 woven plies.

4. The printing blanket of claim 1, wherein the multi-ply woven fabric has a warp direction tensile strength of greater than 250 pounds per inch.

5. The printing blanket of claim 1, wherein the multi-ply woven fabric has a residual stretch in the warp direction of less than about 2%.

6. The printing blanket of claim 1, wherein the multi-ply woven fabric has a gauge of between about 13 mils and 42 mils.

7. The printing blanket of claim 1, wherein each woven ply has a gauge of between about 7 mils and 27 mils.

8. The printing blanket of claim 1, wherein the multi-ply woven fabric further comprises stuffer yarns located in the weft direction between at least some of the woven plies.

9. The printing blanket of claim 8, wherein the stuffer yarns have essentially no crimp.

10. The printing blanket of claim 1, wherein the multi-ply woven fabric is at least partially impregnated with an elastomeric compound.

11. A printing blanket comprising a printing surface and a multi-ply woven fabric, wherein the multi-ply woven fabric comprises at least a first ply and a second ply and a plurality of stuffer yarns, each ply comprising warp yarns in the warp direction and weft yarns in a weft direction perpendicular to the warp direction interwoven with the warp yarns, wherein the woven plies are integrated through combined portions formed by interlacing warps and wefts among different woven plies within the multi-ply woven fabric, wherein the stuffer yarns are in the weft direction located between at least two adjacent plies and are not interwoven with the warp yarns of the two adjacent woven plies.

12. The printing blanket of claim 11, wherein the stuffer yarns have essentially no crimp.

13. The printing blanket of claim 11, wherein the weft direction of the multi-ply woven fabric has within about at least 80% of the tensile strength as the warp direction of the multi-ply woven fabric.

14. The printing blanket of claim 11, wherein the multi-ply woven fabric comprises at least 3 woven plies.

15. The printing blanket of claim 11, wherein the multi-ply woven fabric comprises at least 4 woven plies.

16. The printing blanket of claim 11, wherein the multi-ply woven fabric has a weft direction tensile strength of greater than 200 pounds per inch.

17. The printing blanket of claim 11, wherein the multi-ply woven fabric has a residual stretch in the warp direction of less than about 2%.

18. The printing blanket of claim 11, wherein the multi-ply woven fabric has a gauge of between about 18 mils and 42 mils.

19. The printing blanket of claim 11, wherein the multi-ply woven fabric has a gauge of between about 24 mils and 42 mils.

20. The printing blanket of claim 11, wherein the multi-ply woven fabric is at least partially impregnated with an elastomeric compound.
